(19) United States
(12) Patent Application Publication
(10) Pub. No.: US 2024/0171471 A1
(43) Pub. Date: May 23, 2024

(54) TOPOLOGY DISCOVERY IN MULTIDROP ETHERNET NODES

(71) Applicant: Analog Devices International Unlimited Company, Limerick (IE)

(72) Inventors: Frederick Carnegie Thompson, Foynes (IE); John Cullinane, Kilmallock (IE); Seamus Ryan, Co. Tipperary (IE); Alan Martin Barry, Muenchen (DE)

(21) Appl. No.: 18/550,672

(22) PCT Filed: Mar. 31, 2022
(86) PCT No.: PCT/EP2022/058715

§ 371 Date: Sep. 14, 2023

Related U.S. Application Data
(60) Provisional application No. 63/170,080, filed on Apr. 2, 2021.
(60) Provisional application No. 63/170,093, filed on Apr. 2, 2021.

(51) Int. Cl. H04L 41/12; H04L 43/0864

(52) U.S. Cl. CPC H04L 41/12; H04L 43/0864

(57) ABSTRACT

A network node for connecting to a multi-drop network. The network node includes processing circuitry and physical layer (PHY) circuitry for connecting the network node to a shared network link of the multi-drop network. The processing circuitry is configured to: configure the PHY circuitry of another network node into a transmit/receive (TX/RX) loop internal to the network node that includes a PHY transceiver: send a measurement pulse on the TX/RX loop and determine a PHY time delay using a count of the TX/RX loops completed during a time duration: initiate sending. by the PHY circuitry of the other node via the shared network link. measurement pulses to a third network node: detect response pulses received via the shared network link in response to the measurement pulses: and determine a network topology of the other node and the third node using the response pulses.

### CLAIM OF PRIORITY

This application claims the benefit of priority to U.S. Provisional Application Ser. No. 63/170,080, filed Apr. 2, 2021, and U.S. Provisional Application Ser. No. 63/170,093, filed Apr. 2, 2021, which are hereby incorporated by reference herein in their entirety.

### FIELD OF THE DISCLOSURE

This document relates to data communication networks, and in particular to techniques for network topology discover by network nodes.

### BACKGROUND

An area network (e.g., a wide area network (WAN) or a local area network (LAN)) is comprised of multiple network nodes. Information can be communicated among the nodes of the network by sending packets of data according to a protocol (e.g., an Ethernet protocol). In a multi-point network or multi-drop network, the multiple network nodes are connected on a shared network link. It is preferable for the network nodes to be able to automatically determine aspects of the topology of the network configuration.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a block diagram of an example of a low complexity multi-drop network.

FIG. 2 is a flow diagram of an example of a method of measuring the time delay between network nodes on a multi-drop network.

FIG. 3 is an illustration of a simplified multi-drop network that shows portions of a reference node and another node of the network.

FIG. 4 is flow diagram of another example of a method of measuring the time delay between network nodes on a multi-drop network.

FIG. 5 is an illustration of an example of the physical layer circuitry configured into a transmit/receive loop.

FIG. 6 is a flow diagram of an example of measuring the physical layer time delay of a network node.

FIG. 7 is another illustration of a simplified diagram of portions of a multi-drop network.

FIG. 8 is flow diagram of another example of a method of measuring the time delay between network nodes on a multi-drop network.

FIGS. 9-11 are block diagrams of examples of portions of multi-drop networks.

### DETAILED DESCRIPTION

To reduce the cost of implementing a switched network such as an Ethernet network, a low complexity multi-point or multi-drop network can be implemented using half-duplex devices.

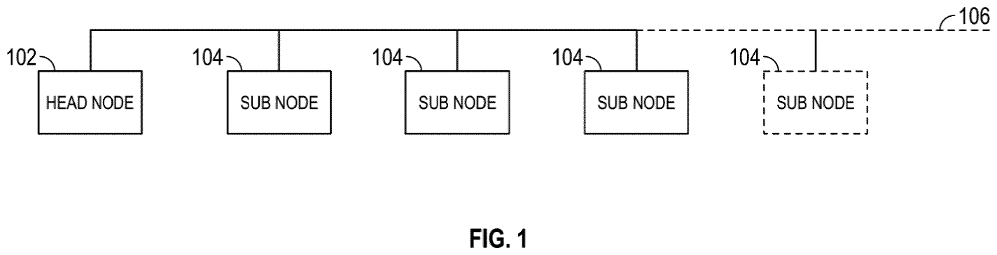

FIG. 1 is a block diagram of an example of a low complexity multi-drop network. The network includes multiple network nodes including a head network node 102 and multiple network devices connected as subordinate network nodes 104 on a shared network link 106 (e.g., a shared cable, a shared twisted wire pair, and the like). All network nodes see all the data that is transmitted on the shared network link. The head node may be any Ethernet-aware device with sufficient processing capability to perform the functions described. Examples include a personal computer (PC), cloud-based server, a programmable logic controller (PLC), electronic control unit (ECU), central/zonal processing unit, or a dedicated controller. The other nodes may also be any Ethernet-aware device and may also be less sophisticated devices such as sensors.

It is desirable for a multi-drop network to perform self-discovery to determine the configuration. Network discovery may include a reference node (e.g., the main node) discovering medium access control (MAC) addresses of the other nodes (e.g., using Dynamic Host Configuration Protocol (DHCP), Link Layer Discovery Protocol (LLDP), Link Layer Topology Discovery (LLTD), and the like). A network node may designate itself as the reference node, or may designate another node as the reference node. Another aspect of the network discovery is measuring the time delay that it takes for a frame to reach a node of the network. This allows the head node to know how much delay will be required to perform a task by another node after the command for the task is sent to the other node. It also provides information on the position of the other node relative to the reference node. Discovery of where a node is on the network can be very useful (e.g., the harness position of an identified node that is a sensor on the bumper of a car. Identification of the harness position identification enables a single skew of end nodes to be maintained, rather than multiple skews that are each identified by the location where they are installed. For example, a car that has 8 identical sensors in all aspects except for some unique identifier (e.g., unique MAC address or unique serialized number sequence of large enough size to never overlap). Any sensor can be installed in any of the 8 positions and its position can be discovered and mapped to the unique identifier. This allows location-based functionality to be implemented using topology discovery information.

The network discovery can include a calibration phase that includes a measurement mode in which a reference node (e.g., a head node or main node) determines and records the time delay in sending a signal to another network node. The position of the other network node relative to the reference node may also be recorded.

The velocity factor or energy travelling over cables is in the range of 60-80 percent of the speed of light. This means that energy travels over one meter of cable in the range of about 4.1 nanoseconds (4.1 nsec) to 5.5 nsec. A measurement resolution of approximately 4 nsec should be used to detect a difference in cable length of 1 meter, and a measurement resolution of approximately 400 picoseconds (400 psec) should be used to detect a difference in cable length of 10 centimeters (10 cm).

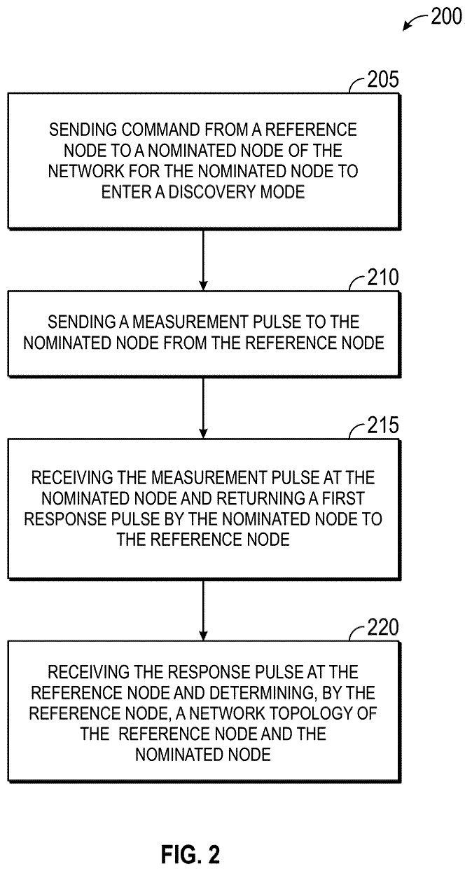

FIG. 2 is a flow diagram of an example of a method of measuring the time delay between network nodes on a multi-drop network. The method 200 can be performed using the multi-drop network example in FIG. 1. At block 205, a reference node sends a command to a node nominated for measurement. The reference node may be any node in the network including the head node or any subordinate node. The nominated node may also be any node in the network. The command causes the nominated node to enter a discovery mode. The other nodes of the network may become silent and do not initiate a communication when the command is sent.

At block 210, the reference node sends a measurement pulse to the nominated node. At block 215, the nominated node detects the measurement pulse while in the discovery mode and returns a response pulse to the reference node in response to receiving the measurement pulse.

At block 220, the reference node receives the response pulse and measures the time delay from the sending of the measurement pulse to the receiving of the response pulse. The pulse widths of the measurement pulse and response pulse are less than the time delay from the sending to the receiving. The time delay determined by the reference node provides the reference node with network topology information.

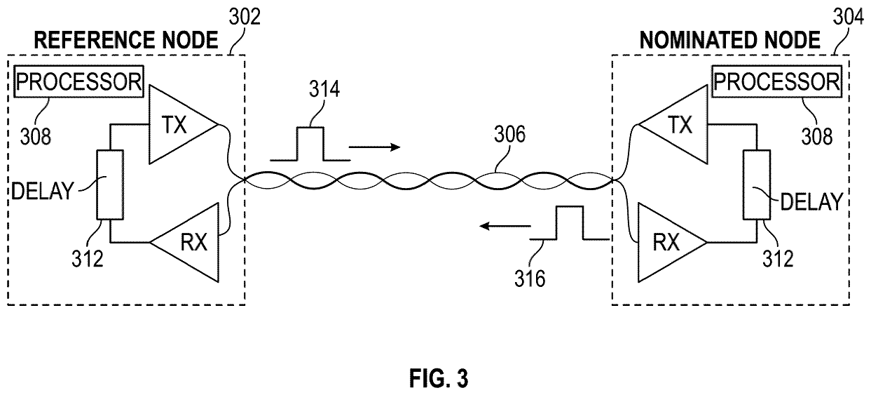

FIG. 3 is an illustration of portions of a simplified multi-drop network that shows a reference node 302 and a nominated node 304. The network may be a portion of a multi-drop network in which data is transmitted to all network nodes using the shared link 306 (e.g., a shared twisted pair). Both the reference node 302 and the nominated node 304 include a host device that includes processing circuitry 308 (e.g., a processor executing instructions, field programmable gate array (FPGA), application specific integrated circuit (ASIC), or other processing circuitry) to perform the functions described, and a transceiver (TX/RX). The transceiver can be included in a physical layer (PHY) of the nodes. The reference node 302 and the nominated node 304 also include delay circuitry 312 that is described elsewhere herein.

In the example of FIG. 3, the discovery mode includes a measurement phase. The calibration phase can include a measurement mode during which the processing circuitry 308 of the reference node measures the distance from the reference node 302 to the nominated node 304. To measure the distance, the reference node generates a measurement pulse 314 that is sent to the subordinate node via the shared link. A response pulse 316 is returned by the subordinate node. The reference node tracks the time duration from sending the measurement pulse to receiving the response pulse and determines the time delay using the time measured time. The distance is determined from the time delay. The time delay from sending the pulses to receiving the pulses may also include the time delay of PHY circuitry of the reference node 302 and the PHY time delay of the nominated node 304. The PHY time delay is the delay from the time the processing circuitry initiates the sending of a pulse to the time the pulse is placed on the shared link 306 by the PHY layer circuitry. The PHY time delays can be used in the calculation of the distance.

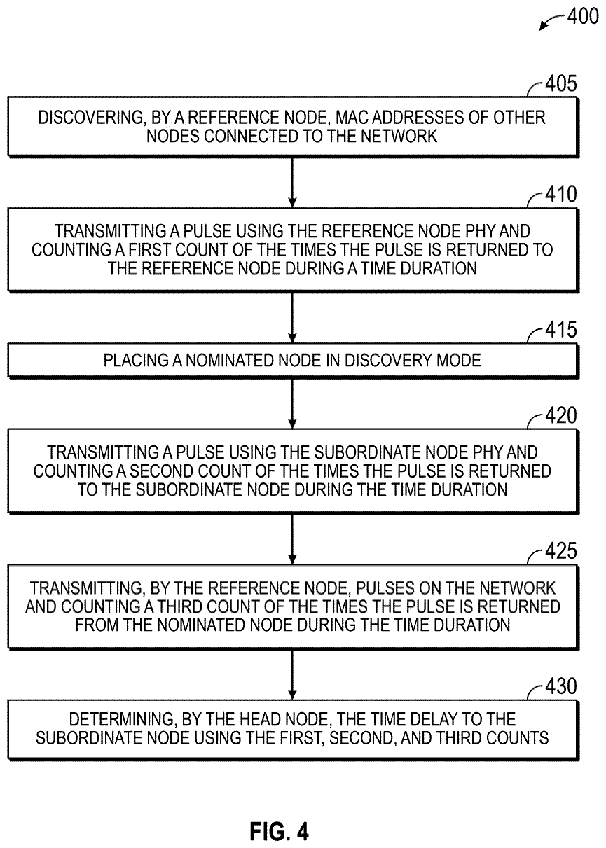

FIG. 4 is flow diagram of another example of a method of measuring the time delay between network nodes on a multi-drop network. The method 400 can be performed using the network example in FIG. 3. At block 405, the reference node 302 (e.g., the head node) discovers the MAC addresses of the other nodes of the network (e.g., using DHCP). The reference node 302 places itself into the measurement mode to measure the time delays to the other discovered nodes of the network. In the measurement mode, the reference node 302 also measures the PHY time delay of the reference node 302. To measure its own the PHY time delay, the reference node 302 configures its PHY circuitry into a TX/RX loop.

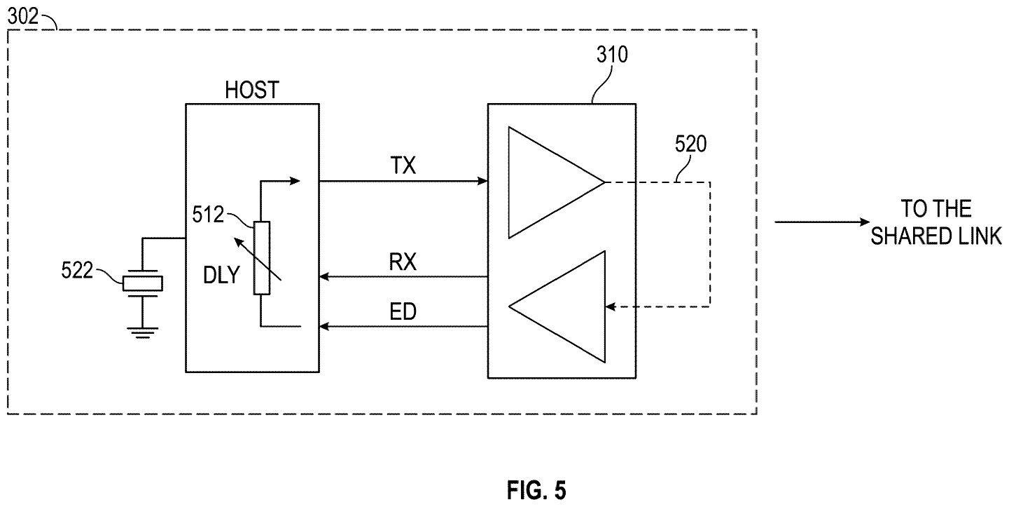

FIG. 5 is an example of the PHY circuitry configured into a TX/RX loop. The TX/RX loop 520 includes the transceiver 310 and delay circuitry 512. The TX/RX loop 520 may also include at least a portion of the board interface network (BIN) circuitry that connects the transceiver 310 to the shared link 306. In some aspects, the TX/RX loop 520 is within an integrated circuit (IC) that includes the transceiver 310, delay circuitry, and BIN circuitry. A crystal 522 is used to derive clock signals used to provide reference timing for the measurements. The delay circuitry 512 may provide a coarse delay that can be simply measured, rather than calibrated. This can simplify the complexity and cost of the implementation.

At block 410, the reference node 302 transmits a measurement pulse from the PHY layer and counts the number times the pulse is returned over the TX/RX loop 520 for a predetermined time duration (e.g., one millisecond, or 1 msec). This number of loops completed (TD_MR_HEAD) during the measurement time duration is recorded (e.g., stored in memory) by the reference node.

At block 415, the reference node 302 places the nominated node 304 into the discovery mode. The other nodes on the network remain silent. To place the nominated node 304 in discovery mode, the reference node 302 may transmit a command frame to the nominated node 304 to be measured (e.g., using the MAC address of the node) and the other nodes stay silent upon detecting the command frame. In the discovery mode, the nominated node 304 configures its PHY circuitry into a TX/RX loop like the loop for the network node in the example of FIG. 5. The TX/RX loop includes the nominated node's transceiver 310, delay circuitry, and may also include BIN circuitry of the nominated node 304.

At block 420, the nominated node 304 transmits a measurement pulse and counts the number times the pulse is returned by the TX/TX loop for the predetermined time duration. This number of loops completed (TD_MR_FIND) may be stored by the nominated node 304 and returned to the reference node 302. In variations, the nominated node determines its PHY time delay using the loop count and returns a value of the PHY time delay to the reference node. Other methods can be used to determine the PHY time delay of the nominated node.

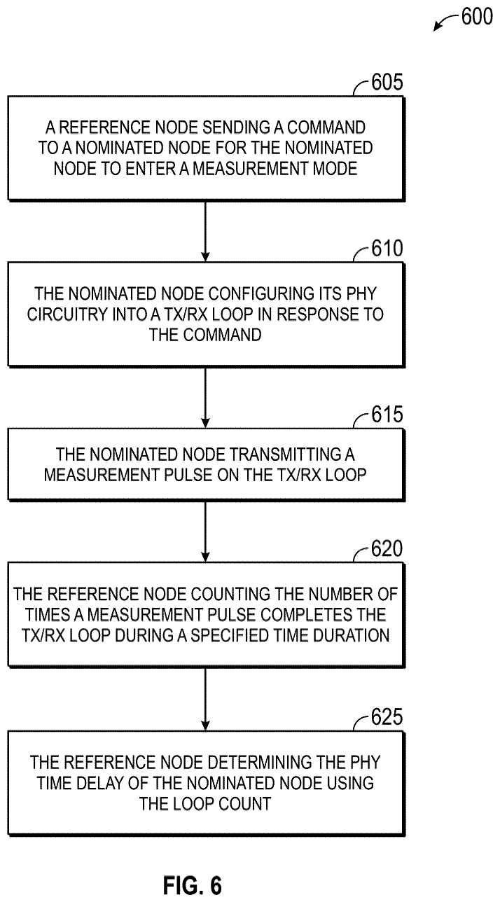

FIG. 6 is a flow diagram of another example of a method 600 of determining the PHY time delay of a nominated node. At block 605, the reference node sends command to the nominated node that causes the nominated node to enter a measurement mode. At block 610, the nominated configures its PHY circuitry into the TX/RX loop internal to the nominated node.

At block 615, the nominated node transmits one or more measurement pulses on the TX/RX loop. At block 620, the reference detects and counts the number of times a measurement pulse completes the TX/RX loop within specific time duration. At 625, the reference node determines the PHY time delay using the determined loop count. When one or both of the loop counts and the PHY time delays are determined, the TX/RX loops can be removed by the reference node 302 and the nominated node 304, and the network nodes return to transmission over the shared link 306.

Returning to FIG. 4 at block 425, the reference node 302 and the nominated node 304 are now configured into a loop that includes the shared link 306. Both the reference node 302 and the nominated node 304 may configure the delay circuitry 312 into the loop. The reference node 302 transmits a measurement pulse over the shared link 306 and detects a response pulse sent back by the nominated node 304 (e.g., a ping-pong transmission). The reference node 302 recurrently sends the pulses for the predetermined time duration and counts the number of loop completions within the time duration (TD_MR).

At block 430, the reference node 302 determines the time delay (t_{distance}) to the nominated node 304 using the three counts (TD_MR_HEAD, TD_MR_FIND, TD_MR). The time delay (in nanoseconds, or nsec) can be determined as

$${t}_{distance ( n s )} = \frac{\begin{matrix}( D {M}_{D U R} + 1 ) * \\ {10}^{6}\end{matrix}}{TD\_MR} - ( \frac{\begin{matrix}( D {M}_{D U R} + 1 ) * \\ {10}^{6}\end{matrix}}{TD\_MR \_HEAD} + \frac{\begin{matrix}( D {M}_{D U R} + 1 ) * \\ {10}^{6}\end{matrix}}{TD\_MR \_FIND} )$$

where DM_DUR is the variable for the predetermined duration time (e.g., 1 msec), TD_MR is the link segment measurement count in that time, TD_MR_HEAD is the reference node PHY measurement count in that time, and TD MR FIND is the nominated node PHY measurement count in that time.

The measurement procedure may be repeated for all other network nodes identified in discovery, such as by looping back to block 410 or looping back to block 415, and reusing the determined TD_MR_HEAD measurement in the time delay calculation for the other network nodes. The time delay t_{distance} for each network node can be used by the reference node 302 to determine when a task is completed by knowing the transmit time delay involved with sending a frame to another network node and how long it will take that network node to process the frame and complete the task.

In the example of FIG. 5, the delay circuitry 512 of a network node may provide a coarse time delay to the measurement pulse. The minimum amount of delay provided by the delay circuity 512 (e.g., ˜160 nsec) should be longer than a pulse width of the measurement pulse to avoid a collision on the shared link 306, and the delay provided by the delay circuitry 512 should be relatively stable over the measurement time (e.g., 1 msec). The crystal 522 may have drift over the measurement time (e.g., +50 ppm drift, or ˜4 nsec over 1 msec measurement time). A relatively stable delay will avoid integrating the crystal inaccuracy over a period of time longer than the delay time of the delay circuitry 512.

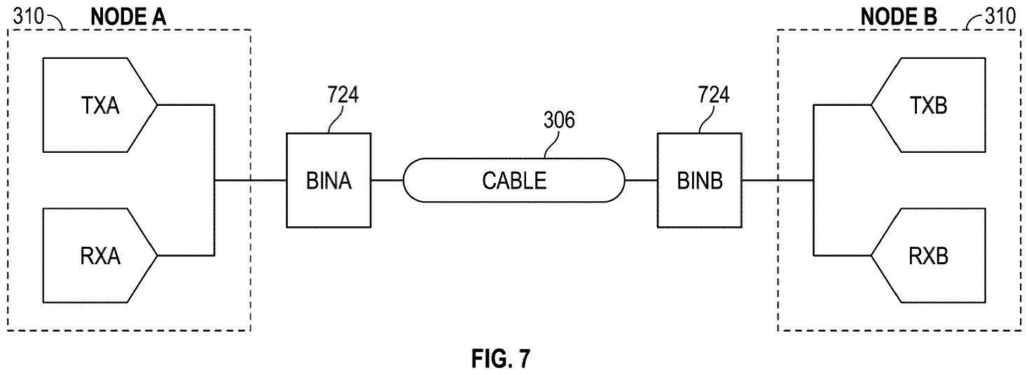

FIG. 7 is another illustration of a simplified diagram of portions of a multi-drop network. The diagram includes the transceiver 310 (TX/RX) and board interface network (BIN) circuitry 724 of the physical (PHY) layer of a reference node (Node A) of the network and a nominated network node (Node B) of the network that is to be measured. All nodes of the multi-drop network are connected via the shared network link 306. When in the measurement mode, a pulse signal is sent from Node A via the shared link 306 to Node B. A returned pulse is received by Node A that is sent back by Node B after a delay of processing by the transceiver 310 and BIN circuitry 624 of Node B. If the processing time of Node B is 160 nsec, the time delays (T_{DELAY}) seen at Node A are:

T_{DELAY_TXA}+T_{DELAY_BINA}+T_{DELAY_CABLE}+T_{DELAY_BINB}+T_{DELAY_RXB}+T_{DELAY_TXB}+T_{DELAY_BINB}+T_{DELAY_CABLE}+T_{DELAY_RXA}+(T_{CLOCK_DELAY}−(T_{DELAY_RXB}+T_{DELAY_TXB)}),

where (T_{CLOCK_DELAY}−(T_{DELAY_RXB}+T_{DELAY_TXB})) is the time delay due to processing internal to Node B.

The T_{CLOCK_DELAY} comes from assuming that there is a four clock period delay in addition to the delay through the transceiver 310 of Node B. If the node clock is a 25 Mega Hertz (25 MHz) clock, T_{CLOCK_DELAY} (the four clock period delay) is 160 nsec. The BIN delay (T_{DELAY_BINA} or T_{DELAY_BINB}) is a delay for the circuit components between the connector and the integrated circuit (IC) that can change depending on factors of the implementation, such as the application and the IC vendor etc. The delay (T_{DELAY_BINX}) is a generic delay term that covers the delay for all the components of the board interface network circuitry of the node. The BIN delay can be treated in different ways in the calculations. The BIN delay may be assumed to be small enough to be negligible, the BIN delay may be treated as a fixed error in the system, or the BIN delay may be a value given to each node (e.g., a value for each node stored in memory of the node) to be added to the (T_{DELAY_RXB}+T_{DELAY_TXB}) term before being subtracted from 160 nsec in the (160 nsec−(T_{DELAY_RXB}+T_{DELAY_TXB})) term.

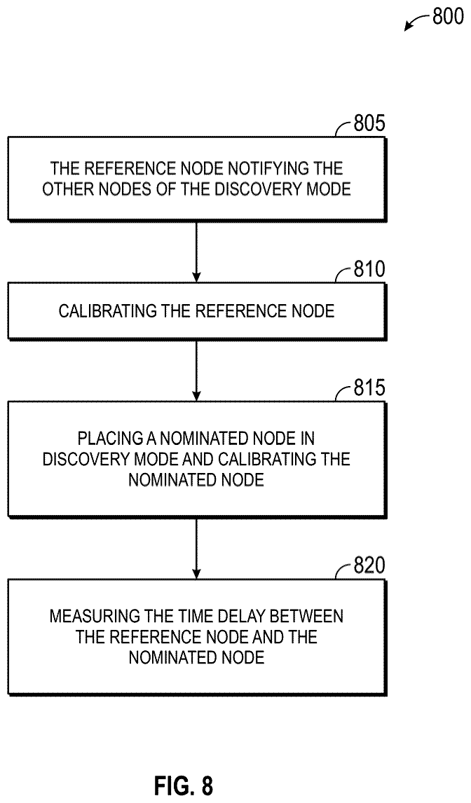

FIG. 8 is a flow diagram of another example of a method of measuring the time delay between network nodes on a multi-drop network. The method 800 can be performed using the multi-drop network example in FIG. 7.

At block 805, the reference node (e.g., Node A in FIG. 7) advertises a discovery mode in which the reference node self-calibrates and the other nodes on the network remain silent and do not send a frame over the shared link. The MAC addresses of the other nodes of the network may have been discovered using DHCP.

At block 810, the reference node self-calibrates an internal delay (e.g., a PHY time delay). To self-calibrate, the reference node enters the measurement mode and configures its internal hardware into a TX/RX loop 520 as shown in the example of FIG. 5. The node example in FIG. 5 shows a host device (HOST) and adjustable delay circuitry 512 (DLY) in addition to the transceiver 310. As explained previously herein, the host device includes processing circuitry and the configured hardware TX/RX loop 520 includes the transceiver 310 and adjustable delay circuitry 512. The TX/RX loop 520 may also include at least a portion of the BIN circuitry 624 that connects the transceiver 310 to the shared link 306.

As part of the self-calibration, the host device of the reference node 302 sends a pulse into the transmitter (TX) of the transceiver 310 and waits for a receive pulse to be received by the receiver (RX) of the transceiver 310 via the internal TX/RX loop 520. The host device determines how long it takes for the receiver RX to see the pulse. The difference in time between sending the TX pulse and receiving the RX pulse is measured. The internal delay circuitry 512 of the reference node 302 may be adjusted (e.g., by adjusting a delay line of the delay circuitry) accordingly to make this time difference a predetermined time duration. This desired predetermined time duration may be a parameter stored (e.g., in memory) in the reference node 302. In some aspects, the measurement may be taken multiple times and averaged if there is a variation in the measurements.

At block 815, the reference node nominates or indicates a node for measurement. To nominate a node, the reference node may send a command frame that causes the nominated node to enter the discovery mode. The other nodes on the network remain silent. The nominated node 304 self-calibrates its internal delay using the measurement mode performed by the reference node by configuring itself into a TX/RX loop as in the example of FIG. 5. The nominated node 304 transmits a pulse, waits for a receive pulse, and adjusts its delay circuitry accordingly. For example, the nominated node may store a predetermined time duration and adjusts its delay circuitry according to the predetermined time duration (e.g., so that the delay in the TX/RX loop matches the predetermined time duration of the reference node).

At block 820, the time delay between the reference node 302 and the nominated node 304 is measured after the two nodes are self-calibrated. A measurement pulse is sent from the reference node 302 to the nominated node 304, the reference node 302 receives a response pulse back from the nominated node 304, as in the ping-pong communication described regarding the method example of FIG. 4. The time delay between the reference node 302 and the nominated node 304 is the measured delay from sending the pulse to receiving the pulse. In addition to the time delay, the position of the nominated node 304 on the shared link 306 relative to the reference node 302 may also be determined and recorded by the reference node 302.

The measurement procedure may be repeated for all the nodes with MAC addresses identified in discovery. The time delay for each node can be used by the reference node 302 to determine the position of the nominated nodes relative to the reference node 302 and thereby the reference node 302 determines the network topology. The time delay can also be used by the reference node 302 to determine when a task is completed by another node (e.g., a subordinate node) by knowing how long it will take to send a frame to the other node and how long it will take the other node to process the frame and complete the task. Although the reference node 302 has been described as measuring the time delay any network node may perform the measurements if desired.

The methods described allow for self-discovery of the topology of a multi-drop network by nodes of the network. If the end nodes of the multi-drop network are known and the intermediate nodes of the multi-drop network are already calibrated, then a faster topology discovery may be performed.

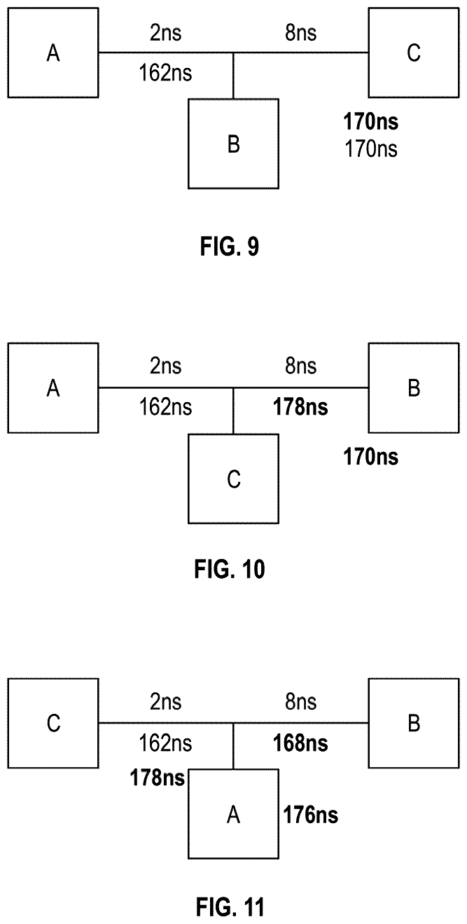

FIG. 9 is a block diagram of an example of a portion of a multi-drop network that includes three nodes Node A, Node B, and Node C. Assume that Node A is a reference node, Node B is the nominated node, and Node C is a listening node different from the nominated node. All the nodes have self-calibrated their internal delay by adjusting their delay circuitry. Node A sends out the measurement pulse, and the pulse arrives at Node B at t=2 nsec. Node C detects the pulse sent to node B. The measurement pulse sent out by Node A also arrives at Node C at time t=10 ns. Because Node B is the nominated node, Node B detects the pulse and sends back a reply pulse at 162 nsec (arrival time 10 nsec plus the 160 nsec internal processing time of Node C). Node C detects the pulse sent by node C and measures the time difference between detecting the pulse from Node A to detecting the pulse from node C to determine its position in the network relative to Node A and Node C. Node C can determine the time delay from Node C to Node B by subtracting the internal time delay of Node C from the measured time difference. Thus, the topology of more than one network node can be determined by Node A by sending one pulse. The reply pulses identify the Node C is a downstream node from Node B, or that Node B and Node C are in the same position if the reply pulses are within measurement resolution. The topology discovery mode would be changed so that more than one node can listen and reply to the measurement pulse instead of all but the nominated node remaining silent.

FIG. 10 is a block diagram of another example of a portion of a multi-drop network that includes three nodes Node A, Node B, and Node C. Assume that Node A is a reference node, and all the nodes have self-calibrated their internal delay and Node B is the nominated node and Node C is a listening node different from the nominated node. In the example of FIG. 10, Node C is placed closer to Node A than Node B. The measurement pulse from Node A arrives at Node B at t=10 nsec, and Node B sends back a reply pulse at 170 nsec. The measurement pulse from Node A arrives at Node C at t=2 nsec and Node C would send back a reply pulse at t=162 nsec if it were not in listening mode. The reply pulse form Node B arrives at Node C at 178 nsec (170 nsec+8 nsec). The difference between the time Node C would have sent the reply pulse and the time the reply pulse from Node B arrives at Node C corresponds to two times (2×) the distance between Node B and Node C. If the two end nodes (Node A and Node B) are known, then measuring the distance between the end Nodes after all other nodes have calibrated their internal delay gives their relative position on the multi-drop network.

FIG. 11 is a block diagram of another example of a portion of a multi-drop network that includes three nodes Node A, Node B, and Node C. Assume that Node A is a reference node, and all the nodes have self-calibrated their internal delay and Node B is the nominated node and Node C is a listening node different from the nominated node. In the example of FIG. 11, Node A is between Node B and Node C. Node A sends out a measurement pulse, and the pulse arrives at Node B at t=8 nsec. The measurement pulse from Node A arrives at Node C at t=2 nsec, and Node C would have sent a reply pulse back to Node A at 162 nsec. The reply pulse from Node B arrives at Node C at 178 nsec. The difference in time allows the reference node to determine which node is on its left side of Node A in the network of FIG. 10 and which node is on its right side of Node A in the network. If the reference node is equidistant from the other two nodes it may not be possible for the reference node to determine which node is on the left side and which on the right side.

The difference in time when Node C would have sent its reply pulse and when Node C receives the reply pulse sent by Node B corresponds to 2× the distance between Node A and Node B. This could be used as a reliability check on the measurement by the reference node on the distance between Node A and Node B. This gives additional accuracy and a redundant measurement which may be useful in functional safety applications. Also, if the time delay between Node A and Node C is TAC, the time delay between Node A and Node B is TAB and the longest time delay is Tlongest, then 2*TAC=2*Tlongest−2*TAB.

The devices, systems and methods described herein allow for network topology discovery to be performed in a digital fashion without the need for accurate measurement pulses with tightly controlled edges. Discovery of the topology of a multi-drop network is provided by a reference node measuring time delay to other nodes in the network. The reference node may measure the internal delay of the nominated nodes. This removes the need for the measured nodes to have an accurate clock reference. This allows lower accuracy clock sources and delay blocks to be used in the nominated nodes compared to networks that use other methods of network topology discovery. This reduces the complexity and cost for time delay calibration. The examples described herein have no clock crystal accuracy requirement and consequently may have a lower bill-of-material (BOM) to implement.

FIGS. 9-11 illustrate examples of how the topology discovery can be shortened if more than one network node is allowed to listen during the ping-pong communication and the nodes of the network have self-calibrated. Thus, network topology can be discovered without the reference node having to send a ping-pong communication to each node of the network, and the number of ping-pong communications needed to determine the topology can be reduced if an accurate measure of time delay is available. This can provide a quick method of checking whether or not a node is downstream from another node.

### Additional Description and Aspects

Aspect 1 can include subject matter (such as a network node) including physical layer (PHY) circuitry for connecting the network node to a shared network link of the multi-drop network; and processing circuitry operatively coupled to the PHY circuitry. The processing circuitry is configured to designate a reference node and a nominated node from among the multiple network nodes, configure PHY circuitry of the reference node into a reference node transmit/receive (TX/RX) loop internal to the reference node that includes a PHY transceiver of the reference node, initiate sending a measurement pulse on the reference node TX/RX loop and determine a reference PHY time delay using a count of the reference node TX/RX loops completed during a time duration, configure PHY circuitry of the nominated node PHY circuitry into a nominated node transmit/receive (TX/RX) loop internal to the nominated node that includes a PHY transceiver of the nominated node, initiate sending a measurement pulse on the nominated node TX/RX loop and determine a nominated PHY time delay using a count of the nominated node TX/RX loops completed during a time duration, initiate sending multiple measurement pulses from the reference node to the nominated node via the shared network link, detect response pulses received via the shared network link in response to the measurement pulses, and determine a network topology of the reference node and the nominated node using the response pulses.

In Aspect 2, the subject matter of Aspect 1 optionally includes the processing circuitry of the network node further configured to measure the delay of the nominated node by counting the number of pulses seen during a fixed time interval while the nominated node is looping a pulse.

In Aspect 3, the subject matter of one or both of Aspects 1 and 2 optionally include the PHY circuitry of the reference node and the nominated node including a delay circuit. The processing circuitry of the network node is configured to configure the reference node and nominated node TX/RX loops to include the respective PHY transceiver and delay circuit, determine the PHY time delay of the reference node and the nominated node by initiating sending of PHY delay measurement pulses and detecting a return of the PHY delay measurement pulse by the reference and nominated TX/RX loops, and including the respective PHY time delays in the determined transmit time delay.

In Aspect 4, the subject matter of Aspect 3 optionally includes the processing circuitry of the network node configuring each of the reference node and nominated node TX/RX loops to include the PHY transceiver, the delay circuit, and board interface network (BIN) circuitry that connects the PHY transceiver of the respective node to the shared network link.

In Aspect 5, the subject matter of Aspect 3 optionally includes a delay circuit that adds a time delay to cause the PHY time delay to be longer than a pulse width of the measurement pulse.

In Aspect 6, the subject matter of one or any combination of Aspects 1-5 optionally includes the processing circuitry of the network node configured to determine a value of the PHY time delay of the nominated node; and include the PHY time delay of the nominated node in the determined transmit time delay.

In Aspect 7, the subject matter of one or any combination of Aspects 1-6 optionally includes the PHY circuitry of the reference node and the nominated node including a delay circuit. The processing circuitry of the network node is configured to configure the PHY circuitry into an internal transmit/receive (TX/RX) loop that includes a PHY transceiver and the delay circuit, calculate a PHY time delay, and adjust the delay circuit to set the PHY time delay to a predetermined PHY time delay.

In Aspect 8, the subject matter of one or any combination of Aspects 1-7 optionally includes the processing circuitry of the network node configured to detect another response pulse from a listening node of the network; and determine relative position of the nominated node and listening node to the network node.

Aspect 9 includes subject matter (such as a method of operating a multi-drop network including multiple network nodes connected to a shared network link) or can optionally be combined with one or any combination of Aspects 1-8 to include such subject matter, comprising configuring PHY circuitry of a reference node of the network into a transmit/receive (TX/RX) loop internal to the reference node, determining a PHY time delay of the reference node by sending one or more measurement pulses over the TX/RX loop and counting the number of TX/RX loops completed during a time duration, sending, by the reference node to a nominated node of the network, a command for the nominated node to enter a discovery mode, sending multiple measurement pulses to the nominated node from the reference node, returning response pulses from the nominated node to the reference node in response to the measurement pulses, and determining, by the reference node, a network topology of the reference node and the nominated node using the response pulses.

In Aspect 10, the subject matter of Aspect 9 optionally includes transmitting one or more measurement pulses by the reference node and determining a count of times the pulses are returned by the nominated node during a time duration, and wherein the determining the network topology includes determining a transmit time delay from the reference node to the nominated node using the determined count and the determined PHY time delay.

In Aspect 11, the subject matter of Aspect 10 optionally includes calculating, by the reference node, a time delay of physical layer (PHY) circuitry of the nominated node; and wherein the determining the transmit time includes determining the transmit time delay using the calculated PHY time delay of the nominated node.

In Aspect 12, the subject matter of Aspect 11 optionally includes the nominated node configuring PHY circuitry of the nominated node into a TX/RX loop; and the nominated node transmitting measurement pulses on the TX/RX loop to measure the PHY time delay for the reference node.

In Aspect 13, the subject matter of Aspect 12 optionally includes the reference node detecting and counting the number of TX/RX loops completed within a measurement time.

In Aspect 14, the subject matter of Aspect 12 optionally includes the nominated node counting the number of TX/RX loops completed within a measurement time and sending the count to the reference node.

In Aspect 15, the subject matter of one or any combination of Aspects 12-14 optionally includes the nominated node configuring the PHY circuitry into a TX/RX loop that includes a PHY transceiver, a delay circuit, and a board interface network (BIN) circuitry that connects the PHY transceiver to the shared network link, and wherein the calculated PHY time delay includes a time delay of the PHY transceiver, a time delay of the delay circuit, and a time delay of the BIN circuitry.

In Aspect 16, the subject matter of one or any combination of Aspects 12-15 optionally includes configuring, by the nominated node in response to the command, PHY circuitry of the nominated node into a TX/RX loop that includes the PHY transceiver and a delay circuit; calculating, by the nominated node, a time delay of the delay circuit; and setting, by the nominated node, the time delay of the delay circuit to a predetermined time delay.

In Aspect 17, the subject matter of one or any combination of Aspects 9-16 optionally includes the reference node including, in the TX/RX loop, a PHY transceiver and one or more of a coarse delay circuitry and a board interface network (BIN) circuitry that connects the PHY transceiver to the shared network link.

In Aspect 18, the subject matter of one or any combination of Aspects 9-17 optionally includes the reference node setting the PHY time delay of the reference node to a predetermined PHY time delay.

In Aspect 19, the subject matter of one or any combination of Aspects 9-19 optionally includes detecting the measurement pulse by a listening node of the network; detecting, by the listening node, a response pulse from the nominated node; and calculating, by the listening node, a time delay between the nominated node and the listening node in response to detecting the measurement pulse and the response pulse.

In Aspect 20, the subject matter of Aspect 19 optionally includes determining, by the listening node, relative position of the nominated node and listening node to the reference node.

Aspect 21 includes subject matter (or can optionally be combined with one or any combination of Aspects 1-20 to include such subject matter) such as a computer-readable storage medium containing instructions, which when performed by processing circuitry of a reference network node of a multi-drop network, cause the reference node to perform actions including: configuring PHY circuitry of a reference node of the network into a transmit/receive (TX/RX) loop internal to the reference node; determining a PHY time delay of the reference node by sending one or more measurement pulses over the TX/RX loop and counting the number of TX/RX loops completed during a time duration; sending, by the reference node to a nominated node of the network, a command for the nominated node to enter a discovery mode; sending multiple measurement pulses to the nominated node from the reference node; returning response pulses from the nominated node to the reference node in response to the measurement pulses; and determining, by the reference node, a network topology of the reference node and the nominated node using the response pulses.

In Aspect 22, the subject matter of Aspect 21 optionally includes the computer-readable storage medium further including instructions that cause the reference node to perform actions including: calculating a time delay from sending the measurement pulses to receiving the response pulses; receiving from the nominated node in response to the command, a PHY time delay of the nominated node; and determining a transmit time delay from the reference node to the nominated node using the time delay from sending the measurement pulse to receiving the measurement pulse, the PHY time delay of the reference node, and the PHY time delay of the nominated node.

These non-limiting Aspects can be combined in any permutation or combination. The above detailed description includes references to the accompanying drawings, which form a part of the detailed description. The drawings show, by way of illustration, specific embodiments in which the invention can be practiced. These embodiments are also referred to herein as “examples.” All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the described aspects. Also, in the above Detailed Description, various features may be grouped together to streamline the disclosure. This should not be interpreted as intending that an unclaimed disclosed feature is essential to any aspect. Rather, inventive subject matter may lie in less than all features of a particular disclosed embodiment.

1. A multi-drop network including multiple network nodes, the network including:
a first network node including:
physical layer (PHY) circuitry for connecting the network node to a shared network link of the multi-drop network; and
processing circuitry operatively coupled to the PHY circuitry and configured to:
designate a reference node and a nominated node from among the multiple network nodes;
configure PHY circuitry of the reference node into a reference node transmit/receive (TX/RX) loop internal to the reference node that includes a PHY transceiver of the reference node;
initiate sending a measurement pulse on the reference node TX/RX loop and determine a reference PHY time delay using a count of the reference node TX/RX loops completed during a time duration;
configure PHY circuitry of the nominated node PHY circuitry into a nominated node transmit/receive (TX/RX) loop internal to the nominated node that includes a PHY transceiver of the nominated node;
initiate sending a measurement pulse on the nominated node TX/RX loop and determine a nominated PHY time delay using a count of the nominated node TX/RX loops completed during a time duration;
initiate sending multiple measurement pulses from the reference node to the nominated node via the shared network link;
detect response pulses received via the shared network link in response to the measurement pulses; and
determine a network topology of the reference node and the nominated node using the response pulses.

2. The network of claim 1, wherein the processing circuitry of the network node is further configured to measure the delay of the nominated node by counting the number of pulses seen during a fixed time interval while the nominated node is looping a pulse.

3. The network of claim 1, wherein the PHY circuitry of the reference node and the nominated node includes a delay circuit to cause the PHY time delay to be longer than a pulse width of the measurement pulse.

4. The network of claim 3, wherein the reference node TX/RX loop and the nominated node TX/RX loop include the PHY transceiver, the delay circuit, and board interface network (BIN) circuitry that connects the respective PHY transceiver to the shared network link.

5. The network of claim 1, wherein the PHY circuitry of the reference node and the nominated node includes a delay circuit, and the processing circuitry of the network node is configured to:
configure the PHY circuitry into an internal transmit/receive (TX/RX) loop that includes a PHY transceiver and the delay circuit;
calculate a PHY time delay; and
adjust the delay circuit to set the PHY time delay to a predetermined PHY time delay.

6. The network of claim 1, including:
a listening node separate from the reference node and the nominated node; and
wherein the processing circuitry of the first network node is configured to:
detect another response pulse from the listening node; and
determine relative position of the nominated node and listening node to the reference node.

7. The network of claim 6, wherein the listening node include processing circuitry configured to:
detect the measurement pulses from the reference node;
detect the response pulses from the nominated node; and
calculate a time delay between the nominated node and the listening node in response to detecting the measurement pulses and the response pulses.

8. The network of claim 7, wherein the processing circuitry of the listening node is configured to determine relative position of the nominated node and listening node to the reference node.

9. A computer-readable storage medium containing instructions, which when performed by processing circuitry of a reference network node of a multi-drop network, cause the reference node to perform actions including:
configuring PHY circuitry of a reference node of the network into a transmit/receive (TX/RX) loop internal to the reference node;
determining a PHY time delay of the reference node by sending one or more measurement pulses over the TX/RX loop and counting the number of TX/RX loops completed during a time duration;
sending, by the reference node to a nominated node of the network, a command for the nominated node to enter a discovery mode;
sending multiple measurement pulses to the nominated node from the reference node;
returning response pulses from the nominated node to the reference node in response to the measurement pulses; and
determining, by the reference node, a network topology of the reference node and the nominated node using the response pulses.

10. The computer-readable storage medium of claim 9, further including instructions that cause the reference node to perform actions including:
calculating a time delay from sending the measurement pulses to receiving the response pulses;
receiving from the nominated node in response to the command, a PHY time delay of the nominated node; and
determining a transmit time delay from the reference node to the nominated node using the time delay from sending the measurement pulse to receiving the measurement pulse, the PHY time delay of the reference node, and the PHY time delay of the nominated node.
